(19) United States
(12) Patent Application Publication
(10) Pub. No.: US 2025/0102744 A1
(43) Pub. Date: Mar. 27, 2025

(54) TECHNOLOGIES FOR FIBER ARRAY UNIT LID DESIGNS

(71) Applicant: Intel Corporation, Santa Clara, CA (US)

(72) Inventors: Feifei Cheng, Chandler, AZ (US); Kumar Abhishek Singh, Phoenix, AZ (US); Peter A. Williams, Phoenix, AZ (US); Ziyin Lin, Chandler, AZ (US); Fan Fan, Chandler, AZ (US); Yang Wu, Chandler, AZ (US); Saikumar Jayaraman, Chandler, AZ (US); Baris Bicen, Chandler, AZ (US); Darren Vance, Gilbert, AZ (US); Anurag Tripathi, Gilbert, AZ (US); Divya Pratap, Hillsboro, OR (US); Stephanie J. Arouh, Phoenix, AZ (US)

(73) Assignee: Intel Corporation, Santa Clara, CA (US)

(21) Appl. No.: 18/476,089

(22) Filed: Sep. 27, 2023

(51) Int. Cl. G02B 6/42

(52) U.S. Cl. CPC G02B 6/423; G02B 6/4239

(57) ABSTRACT

Technologies for fiber array unit (FAU) lid designs are disclosed. In one embodiment, channels in the lid allow for suction to be applied to fibers that the lid covers, pulling the fibers into place in a V-groove. The suction can hold the fibers in place as the fiber array unit is mated with a photonic integrated circuit (PIC) die. Additionally or alternatively, channels can be on pitch, allowing for pulling the FAU towards a PIC die as well as sensing the position and alignment of the FAU to the PIC die. In another embodiment, a warpage amount of a PIC die is characterized, and a FAU lid with a similar warpage is fabricated, allowing for the FAU to position fibers correctly relative to waveguides in the PIC die. In another embodiment, a FAU has an extended lid, which can provide fiber protection as well as position and parallelism tolerance control.

### GOVERNMENT INTEREST

This Invention was made with Government support under Agreement No. N00164-19-9-0001, awarded by NSWC Crane Division. The Government has certain rights in the Invention.

### BACKGROUND

Photonic integrated circuits (PICs) can be used for several applications, such as communications. Efficiently and cheaply aligning optics to couple light into and out of PICs can be a challenge. Approaches such as attachment of optical fiber arrays to PICS may be slow, incompatible with conventional semiconductor packaging processes, and can result in substantial yield and throughput issues.

### BRIEF DESCRIPTION OF THE DRAWINGS

FIG. 1 is a simplified drawing of one embodiment of a system with a photonic integrated circuit (PIC) die and a fiber array unit.

FIG. 2 is a simplified drawing of the system of FIG. 1 showing an exploded view of some of the components of FIG. 1.

FIG. 3 is a simplified drawing of a lid for the fiber array unit of FIG. 1.

FIG. 4 is a front view of the lid of FIG. 3.

FIG. 5 is a cross-sectional view of the lid of FIG. 4.

FIG. 6 is a cross-sectional view of the lid of FIG. 4.

FIG. 7 is a cross-sectional view of the lid of FIG. 4.

FIG. 8 is a cross-sectional view of the lid of FIG. 4.

FIG. 9 is a cross-sectional view of the lid of FIG. 4.

FIG. 10 is a cross-sectional view of the lid of FIG. 4.

FIG. 11 is a cross-sectional view of the lid of FIG. 4.

FIG. 12 is a simplified drawing of one embodiment of a package with PIC dies.

FIG. 13 is a simplified drawing of one embodiment of the PIC dies of FIG. 12.

FIG. 14 is a front view of a PIC die with a lid for a fiber array unit.

FIG. 15 is a simplified drawing of one embodiment of a system with a PIC die and a fiber array unit with an integrated lid.

FIG. 16 is a simplified drawing of a side view of one embodiment of the fiber array unit of FIG. 15.

FIG. 17 is a simplified drawing of a side view of one embodiment of the fiber array unit of FIG. 15.

FIG. 18 is a front view of a PIC die with a lid for a fiber array unit.

FIG. 19 is a front view of a PIC die with a lid for a fiber array unit.

FIG. 20 is a simplified drawing of one embodiment of a system with a photonic integrated circuit (PIC) die and a fiber array unit.

FIG. 21 is a simplified flow diagram of at least one embodiment of a method for manufacturing a system including a PIC die and a fiber array unit.

FIG. 22 is a top view of a wafer and dies that may be included in a microelectronic assembly, in accordance with any of the embodiments disclosed herein.

FIG. 23 is a cross-sectional side view of an integrated circuit device that may be included in a microelectronic assembly, in accordance with any of the embodiments disclosed herein.

FIGS. 24A-24D are perspective views of example planar, gate-all-around, and stacked gate-all-around transistors.

FIG. 25 is a cross-sectional side view of an integrated circuit device assembly that may include a microelectronic assembly, in accordance with any of the embodiments disclosed herein.

FIG. 26 is a block diagram of an example electrical device that may include a microelectronic assembly, in accordance with any of the embodiments disclosed herein.

### DETAILED DESCRIPTION

In various embodiments disclosed herein, a fiber array unit (FAU) is mated with a photonic integrated circuit (PIC) die. In some embodiments, channels are defined in a body of a lid for the FAU. The channels extend from V-grooves in the lid towards optical fibers. By applying vacuum to the channels, the optical fibers can be suctioned to the V-grooves, improving alignment as the FAU is attached. In some embodiments, the PIC die may have some warpage. The lid for the FAU can be formed to compensate for the warpage, allowing for the optical fibers to be aligned to the warped PIC die. In some embodiments, the lid may be integrated into the FAU for better fiber protection and position/parallelism tolerance control. Some embodiments may include combinations of two or more of the features described above.

The approaches presented below can provide a high-yield, high-throughput optical packing solution, allowing for the provision of high-quality and low-cost alignment between a PIC and an FAU. Applications include data center networking, AI training, and disaggregated systems.

As used herein, the phrase “communicatively coupled” refers to the ability of a component to send a signal to or receive a signal from another component. The signal can be any type of signal, such as an input signal, an output signal, or a power signal. A component can send or receive a signal to another component to which it is communicatively coupled via a wired or wireless communication medium (e.g., conductive traces, conductive contacts, air). Examples of components that are communicatively coupled include integrated circuit dies located in the same package that communicates via an embedded bridge in a package substrate and an integrated circuit package attached to a printed circuit board that send signals to or receives signals from other integrated circuit packages or electronic devices attached to the printed circuit board.

In the following description, specific details are set forth, but embodiments of the technologies described herein may be practiced without these specific details. Well-known circuits, structures, and techniques have not been shown in detail to avoid obscuring an understanding of this description. Phrases such as “an embodiment,” “various embodiments,” “some embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or any other manner. “Connected” may indicate elements are in direct physical or electrical contact, and “coupled” may indicate elements co-operate or interact, but they may or may not be in direct physical or electrical contact. Furthermore, the terms “comprising,” “including,” “having,” and the like, as used with respect to embodiments of the present disclosure, are synonymous. Terms modified by the word “substantially” include arrangements, orientations, spacings, or positions that vary slightly from the meaning of the unmodified term. For example, the central axis of a magnetic plug that is substantially coaxially aligned with a through hole may be misaligned from a central axis of the through hole by several degrees. In another example, a substrate assembly feature, such as a through width, that is described as having substantially a listed dimension can vary within a few percent of the listed dimension.

It will be understood that in the examples shown and described further below, the figures may not be drawn to scale and may not include all possible layers and/or circuit components. In addition, it will be understood that although certain figures illustrate transistor designs with source/drain regions, electrodes, etc. having orthogonal (e.g., perpendicular) boundaries, embodiments herein may implement such boundaries in a substantially orthogonal manner (e.g., within +/−5 or 10 degrees of orthogonality) due to fabrication methods used to create such devices or for other reasons.

Reference is now made to the drawings, which are not necessarily drawn to scale, wherein similar or same numbers may be used to designate the same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives within the scope of the claims.

As used herein, the phrase “located on” in the context of a first layer or component located on a second layer or component refers to the first layer or component being directly physically attached to the second part or component (no layers or components between the first and second layers or components) or physically attached to the second layer or component with one or more intervening layers or components.

As used herein, the term “adjacent” refers to layers or components that are in physical contact with each other. That is, there is no layer or component between the stated adjacent layers or components. For example, a layer X that is adjacent to a layer Y refers to a layer that is in physical contact with layer Y.

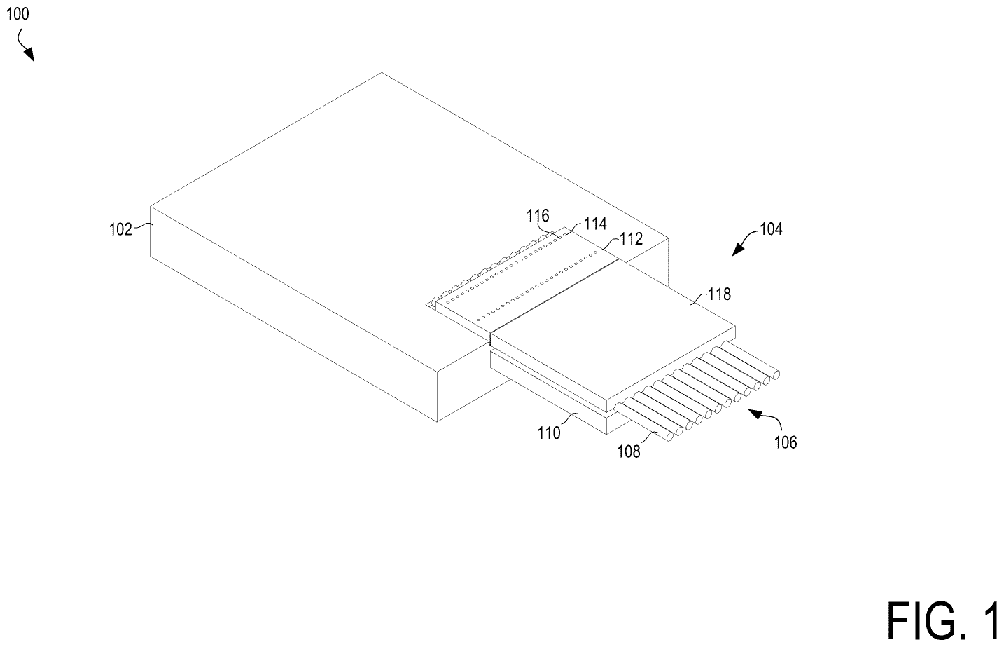

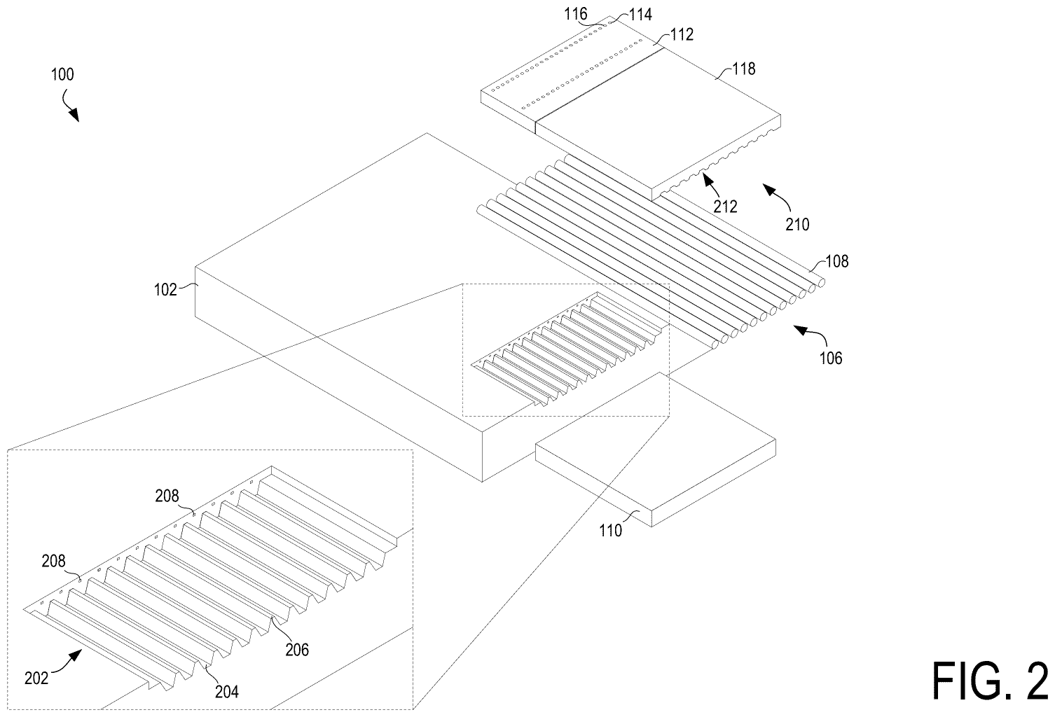

Referring now to FIG. 1, in one embodiment, a system 100 includes a photonic integrated circuit (PIC) die 102 and a fiber array unit (FAU) 104. FIG. 2 shows an exploded view of the system 100. The FAU 104 includes a base 110, an array 104 of optical fibers 108, and a top 118. A lid 112 for the FAU 104 is positioned above the optical fibers 108 and a V-groove array 202 defined in the PIC die 102. The optical fibers 108 are aligned to waveguides 208 defined in the PIC die 102 (see FIG. 2), allowing for light to be coupled between the FAU 104 and the PIC die 102. The optical fibers 108 may extend beyond the FAU 104 (not shown in FIG. 1), and the optical fibers 108 may be connected to one or more connectors, allowing them to be plugged into or otherwise interface with other components.

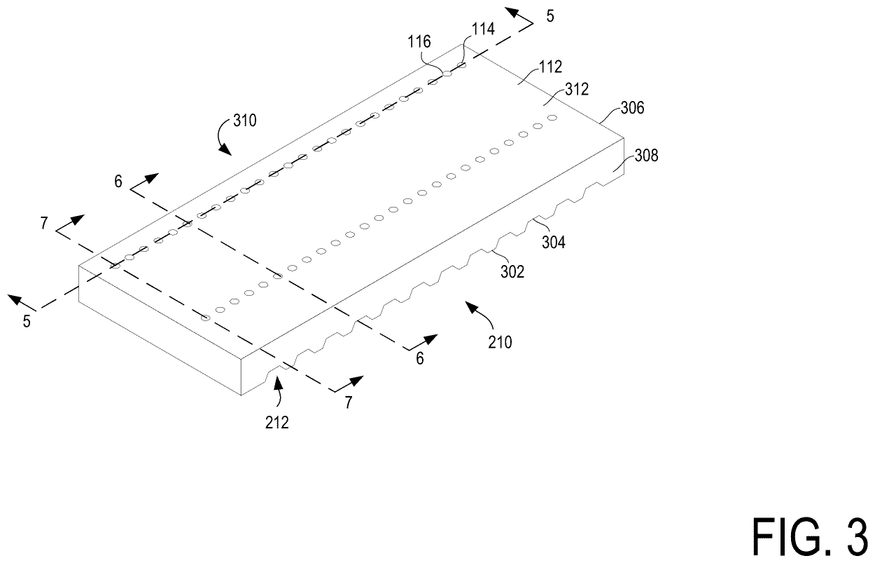

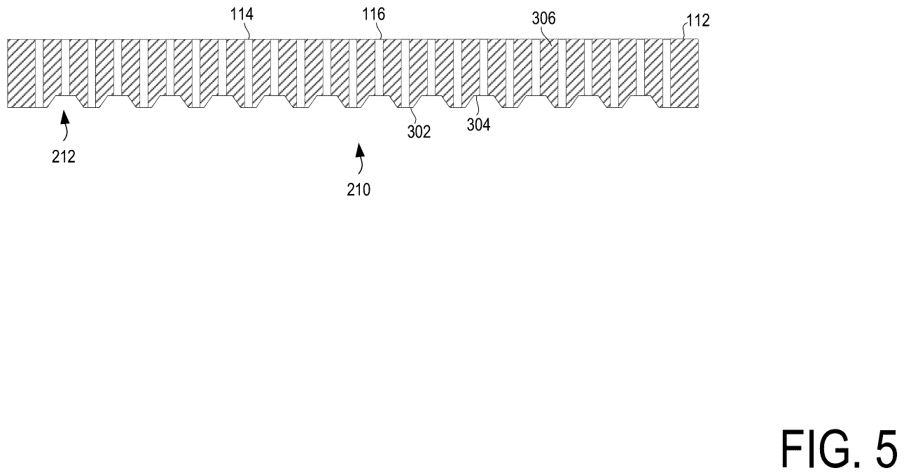

The lid 112 has channels 114 and channels 116 defined in the body 306 of the lid 112. FIG. 3 shows the lid 112, and FIGS. 5-11 show cross-sectional views of various embodiments of the lid 112. The lid 112 includes an array 210 of V-grooves 212. In use, optical fibers 108 are positioned in the V-grooves 212 of the array 210, as shown in FIG. 1. The V-groove array 210 include a series of alternating peaks 302 and valleys 304 that define the V-grooves 212. The V-grooves 212 extend from one face 308 of the lid 112 to an opposite face 310 of the lid 112. The channels 114 extend from the peaks 302 of the V-grooves 212 to the top surface 312 of the lid 112. The channels 116 extend from the valleys 304 of the V-grooves 212 to the top surface 312.

In use, a vacuum or other suction can be applied to the channels 114, 116 when the FAU 104 is being attached to the PIC die 102. The vacuum in the channels 116 can pull optical fibers 108 into the V-grooves 212, reducing twist of the fiber array 106 and improving alignment of the optical fibers 108. Additionally or alternatively, the vacuum in the channels 114 can pull the PIC die 102 towards the lid 112, further improving alignment of the optical fibers 108. In some embodiments, the air flow rate and/or pressure at the channels 114, 116 may be used to sense alignment of the optical fibers 108 relative to the lid 112 and/or alignment of the lid 112 to the PIC die 102. For example, an air flow rate and/or pressure at the channels 114 and/or 116 that is past a threshold may indicate that an optical fiber 108 is aligned or misaligned or may indicate that the lid 112 is aligned or misaligned relative to the PIC die 102.

After the lid 112 is in place with the fibers 108 aligned, the channels 114 and/or channels 116 may be used as fill space for mechanical adhesive, such as epoxy. In an illustrative embodiment, mechanical epoxy is applied at the edges of the lid 112 while suction is applied through the channels 114 and/or 116. The epoxy is cured, and the lid 112 can be released, including removing suction from the channels 114 and/or 116. Additional epoxy can then fill the channels 114 and/or 116 and be cured. Index-matching material can be placed at the interface between the optical fibers 108 and the waveguides 208.

The mechanical adhesive may be any suitable adhesive, such as epoxy or paste. The mechanical adhesive may be conducting or nonconducting. The mechanical adhesive may include filler material, such as monodisperse silica particles. The index-matching material may be any suitable material, such as epoxy or paste. The index-matching material may have any suitable index of refraction, such as 1.4-3.6. In some embodiments, the index-matching material may have an index of refraction between that of the waveguide 208 and the optical fiber 108, reducing reflective coupling loss.

In an illustrative embodiment, the V-groove arrays 202, 210 have a pitch of about 160 micrometers and a depth (i.e., vertical distance between the peaks 206/valleys 206 and/or the vertical distance between the peaks 302/valleys 304) of about 110 microns. In other embodiments, the V-groove arrays 202, 210 may have any suitable pitch or depth, such as 30-500 micrometers.

The V-groove array 210 in the lid 112 may be formed in any suitable manner, such as molding, additive manufacturing, and/or subtractive manufacturing. The V-groove array 202 in the PIC die 102 may be made in any suitable manner, such as by being etched from the substrate of the PIC die 102, such as by using 2D and 3D lithography. In some embodiments, the V-groove array 202 may be formed from another material, such as a material grown on or adhered to the PIC die 102.

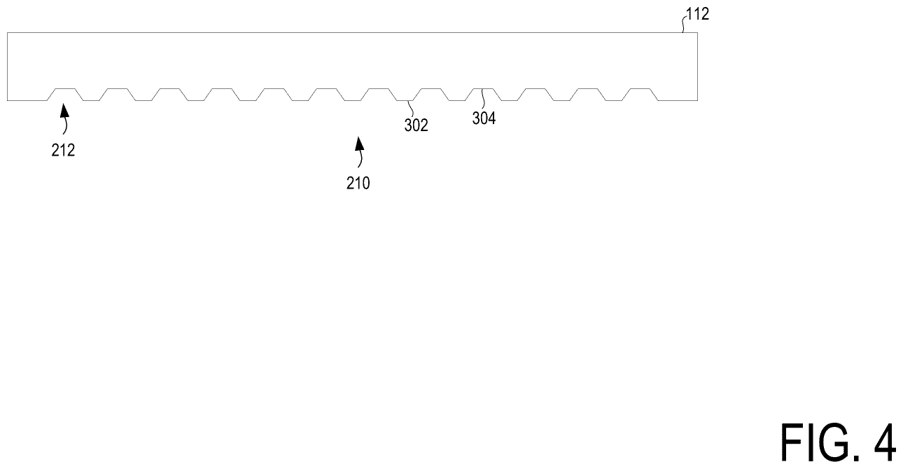

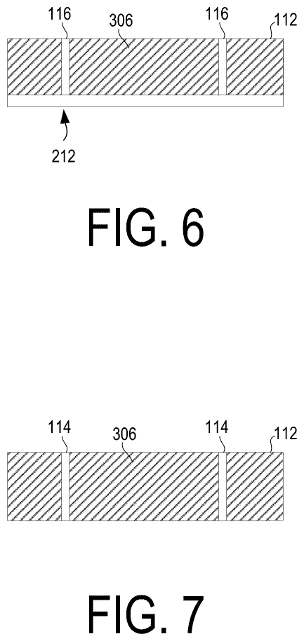

FIG. 4 shows a front view of the lid 112. FIG. 5 shows a cross-sectional view of the lid 112 taken perpendicular to the V-grooves 212, showing the channels 114, 116 extending through the body 306. FIG. 6 shows a cross-sectional view of the lid 112 taken along one of the V-grooves, showing the channels 116 extending through the body 306. FIG. 7 shows a cross-sectional view of the lid 112 taken along one of the peaks 302, showing the channels 114 extending through the body 306.

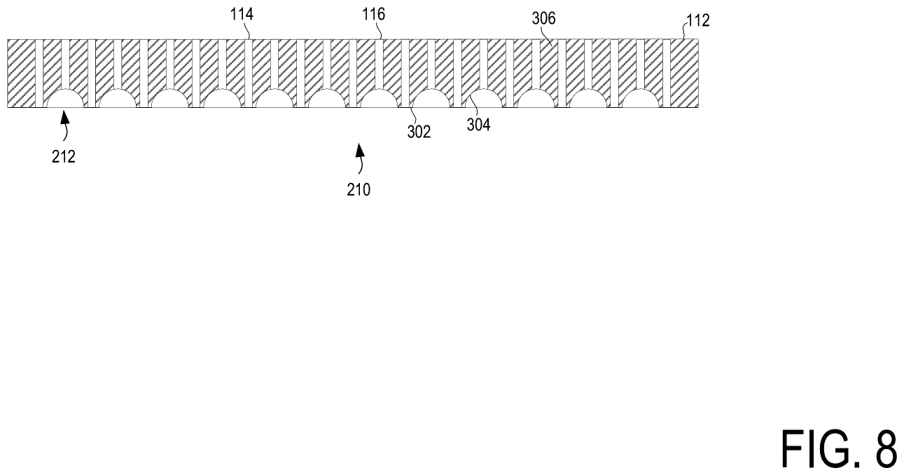

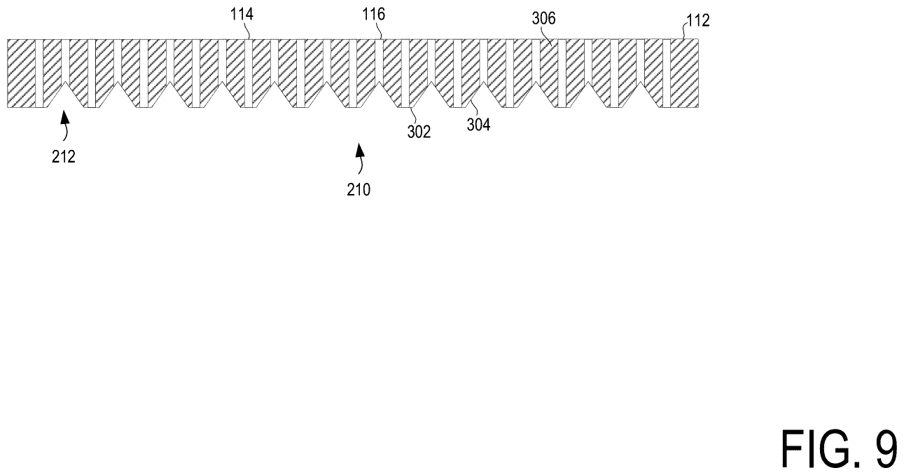

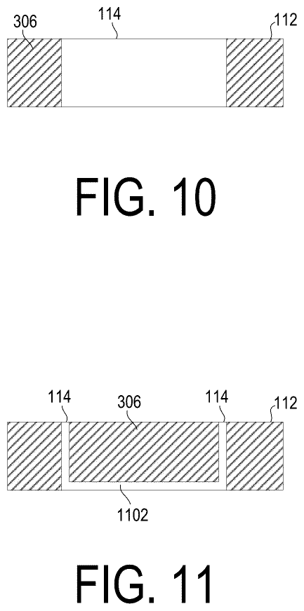

In the illustrative embodiment, the profile of the grooves 212 have a shape similar to half of a hexagon, as shown in FIGS. 3-5. In other embodiments, a different shape for the profile of the grooves 212 may be used, such as a half circle as shown in FIG. 8 or a triangle as shown in FIG. 9. In the illustrative embodiment, the channels 114 are circular channels that extend uniformly through to the peaks 302. In other embodiments, the channels 114 may have a different profile, such as one in which the channels 114 extend parallel to the V-grooves 212, as shown in FIG. 10, or one in which a groove 1102 parallel to the grooves 212 connect the channels 114, as shown in FIG. 11. The approaches shown in FIGS. 10 and 11 may be used to increase the suction force applied between, e.g., the PIC die 102 and the lid 112. Similar approaches may be used to extend the channels 116.

The illustrative base 110, top 118, and cover 112 are made of silicon oxide glass. In other embodiments, the base 110, top 118, and/or cover 112 may be made of any suitable material that may be crystalline, non-crystalline, amorphous, etc., such as fused silica, borosilicate, silicon, rubber, other polymer, etc. The base 110, top 118, and/or cover 112 may have any suitable length or width, such as 5-500 millimeters. The base 110, top 118, and/or cover 112 may have any suitable thickness, such as 0.2-15 millimeters.

The PIC die 102 may be made of any suitable material, such as silicon. In the illustrative embodiment, waveguides 208 are defined in the PIC die 102 that interface with the optical fibers 108 in the FAU 104 to transfer light to or from the PIC die 102. In an illustrative embodiment, waveguides 208 in the PIC die 102 may be silicon waveguides embedded in silicon oxide cladding. The PIC die 102 may include any suitable number of waveguides 208, such as 1-1,024. The FAU 104 may include an optical fiber 108 for each waveguide 208.

The PIC die 102 is configured to generate, detect, and/or manipulate light. The PIC die 102 may include active or passive optical elements such as splitters, couplers, filters, optical amplifiers, lasers, photodetectors, modulators, etc. The PIC die 102 may have electrical connections to a substrate and/or an EIC die, such as for power delivery, sending and receiving data, and/or the like.

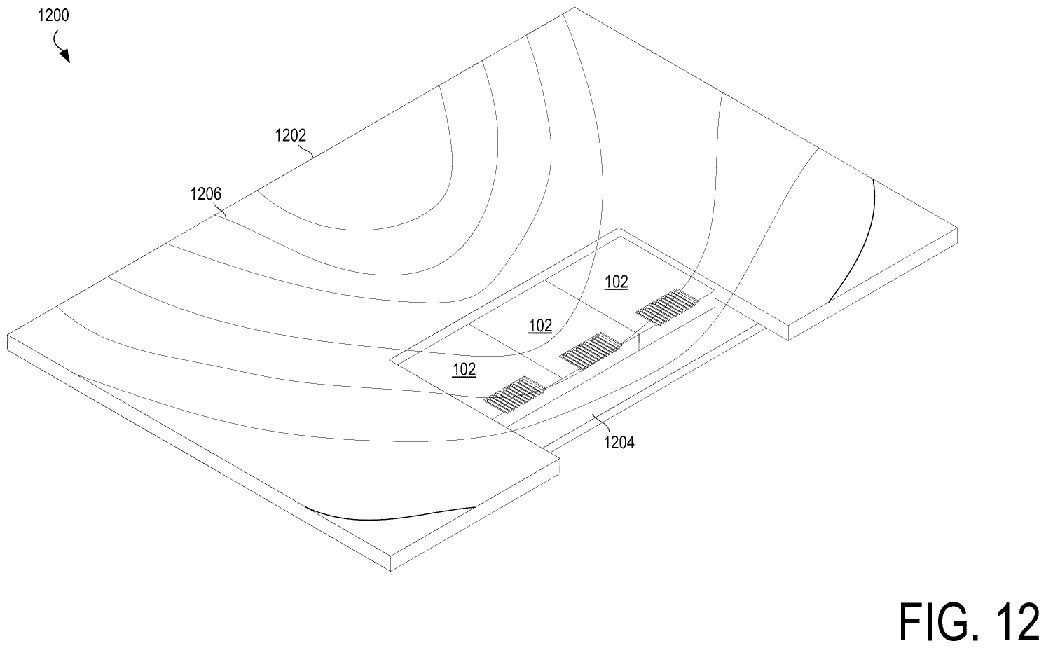

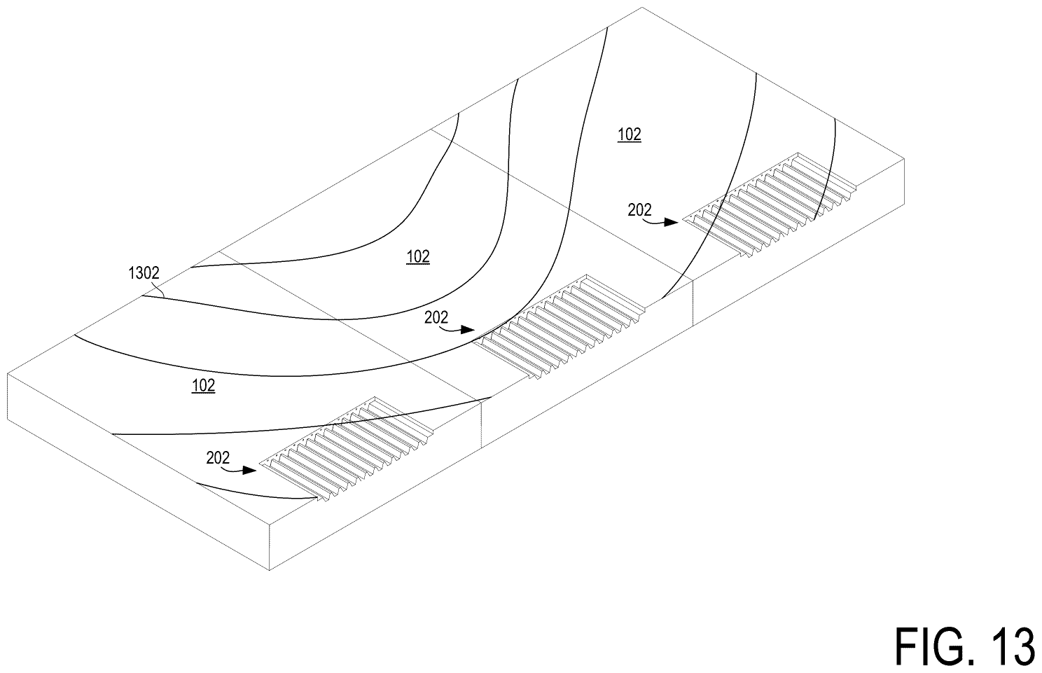

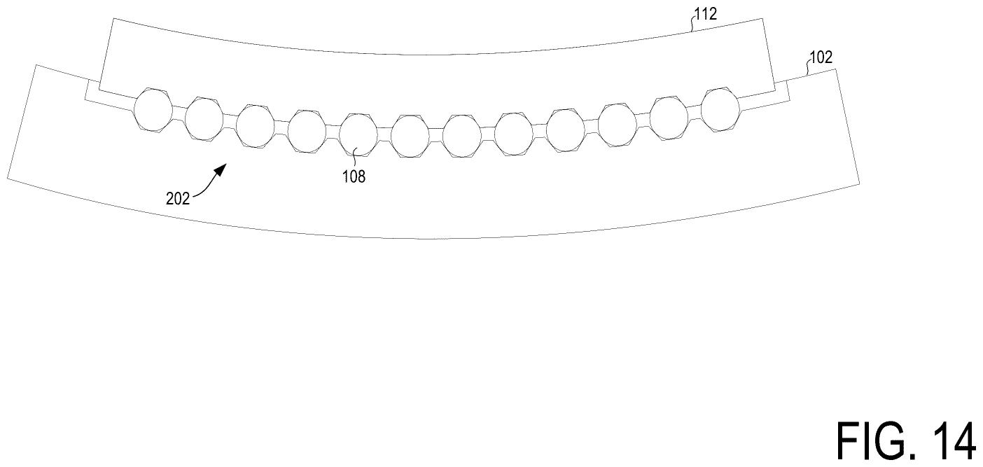

Referring now to FIG. 12, in one embodiment, a package 1200 includes one or more PIC dies 102 packaged with one or more substrates 1202, 1204. Due to various factors such as differences in coefficients of thermal expansion (CTEs), temperature changes during assembly processes, etc., warpage may be induced in the package 1200, as represented by contour lines 1206. The warpage may result in a variation in the z-direction height of the package 1200. The contour lines 1206 represent constant height lines. The warpage may be in the range of, e.g., 75-100 micrometers. FIG. 13 shows the warpage with contour lines 1302 across the PIC dies 102 of the package 1200. The warpage across, e.g., a given V-groove may be, e.g., 1-30 micrometers. A front view of a PIC die 102 and a lid 112 with exaggerated warpage is shown in FIG. 14.

In addition to typical package failure modes associated with warpage, the warpage of the V-groove 202 may result in the V-groove 202 and the waveguides 208 not being collinear, leading to issues for alignment of the fibers 108 and coupling efficiency between the fibers 108 and the waveguides 208. As the alignment precision between the fiber 108 and the waveguides 208 may need to be controlled within 1-2 micrometers for low optical insertion loss, a deviation from collinearity of several micrometers can significantly affect coupling between the fiber 108 and the waveguides 208. With the warpage across waveguides 208 and along the V-groove array 202, it is challenging for typical pick and place tools to place the fiber array 106 into the V-groove array 202 while applying force to press every optical fiber 108 into the V-groove array 202 to conform with the warpage of the PIC die 102. A large offset between the waveguide 208 and the tip of the optical fiber 108 inducing high insertion loss and/or tips of the fibers 108 lifting off from the V-groove array 202 are common issues for down-stream optical package assembly processes.

In order to address this issue, in some embodiments, the lid 112 may be designed to accommodate the warpage in the PIC die 102, as shown in FIG. 14. By accommodating the warpage of the PIC die 102, the tip of each of the fiber 108 can be pressed into the V-groove array 202 and aligned with the corresponding waveguide 808, locking the optical fiber 108 in place during further assembly processes and later use and maintaining good coupling efficiency between each optical fiber 108 and corresponding waveguide 808.

The lid 112 may be manufactured using any suitable approach, such as high-precision machining and/or injection molding glass technologies. The warpage of the package 1200 and/or the PIC die 102 may be characterized, giving a desired amount of curvature for the lid 112.

The lid 112 matching the curvature of the PIC die 102 can help reduce the gap in variation between the lid 112 and the V-groove array 202 of the PIC die 102, improving attachment yield and allowing for higher fiber count and larger piece housing. Additionally, in some embodiments, the lid 112 may include the channels 114 and/or channels 116 discussed above. The lid 112 matching the curvature of the PIC die 102 can allow for relative uniform suction to be applied when applying vacuum to the channels 114 and/or channels 116.

The illustrative substrates 1202, 1204 may be any suitable substrate, such as silicon, glass, ceramic, a circuit board, etc. In some embodiments, the substrates 1202 and/or 1204 is a circuit board made from any suitable material, such as ceramic, glass, and/or organic-based materials with fiberglass and resin, such as FR-4. The substrates 1202 and/or 1204 may have any suitable length or width, such as 10-500 millimeters. The substrates 1202 and/or 1204 may have any suitable thickness, such as 0.2-5 millimeters.

In an illustrative embodiment, the package 1200 shown in FIG. 12 is at one stage of manufacturing an integrated circuit package that will include the PIC die 102 and the FAU 104. The package 1200 may include additional components not shown in FIG. 1 at any suitable stage of a manufacturing process. The substrates 1202 and/or 1204 may support several additional integrated circuit dies, which may be PIC dies, electrical integrated circuit (EIC) dies, or a combination of both. The additional integrated circuit dies may facilitate communication, power delivery, and other suitable connections between the PIC dies 102 and the EIC dies. The EIC dies may include any suitable electronic integrated circuit package, such as resistors, capacitors, inductors, transistors, etc. The EIC dies may include any suitable analog and/or digital circuitry, such as a processor, a memory, an application-specific integrated circuit (ASIC), a field-programmable gate array (FPGA), etc. The EIC dies may be embodied as, form part of, or include a central processing unit (CPU), a graphics processing unit (GPU), or any other processing using (XPU). In some embodiments, the integrated circuit package 1200 may be embodied as a router, a switch, a network interface controller, and/or the like. In such embodiments, the EIC die may include network interface controller circuitry to process, parse, route, etc., network packets sent and received by the integrated circuit package 1200 through the FAU 104. In one embodiment, the integrated circuit component 1200 may be mounted on another component, such as a substrate. The substrate may be, e.g., a motherboard, another circuit board connecting the integrated circuit package 1200 with other components, a housing, etc.

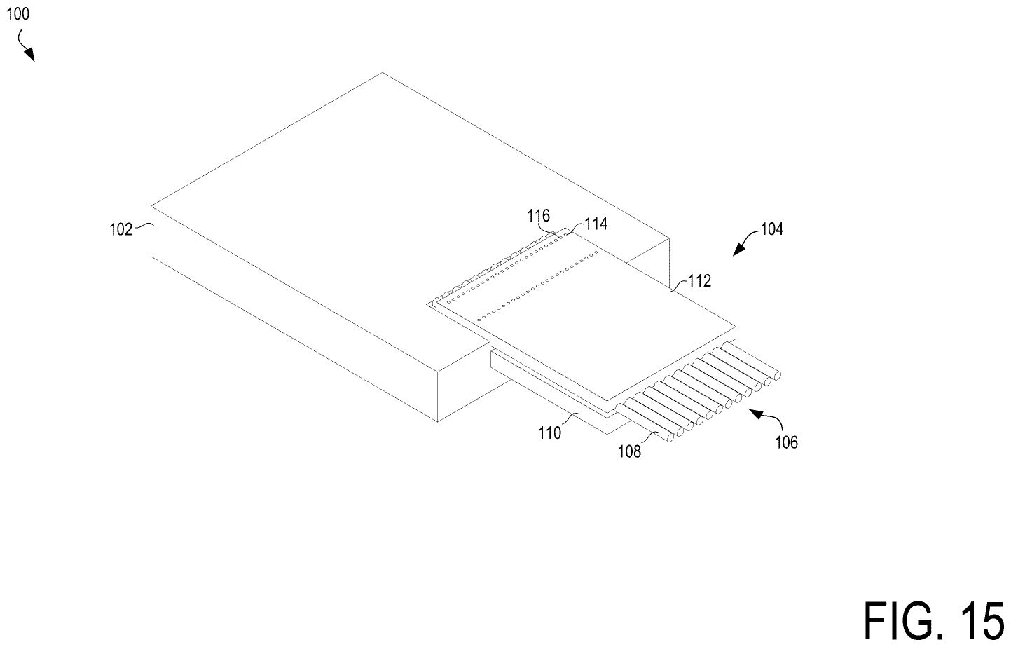

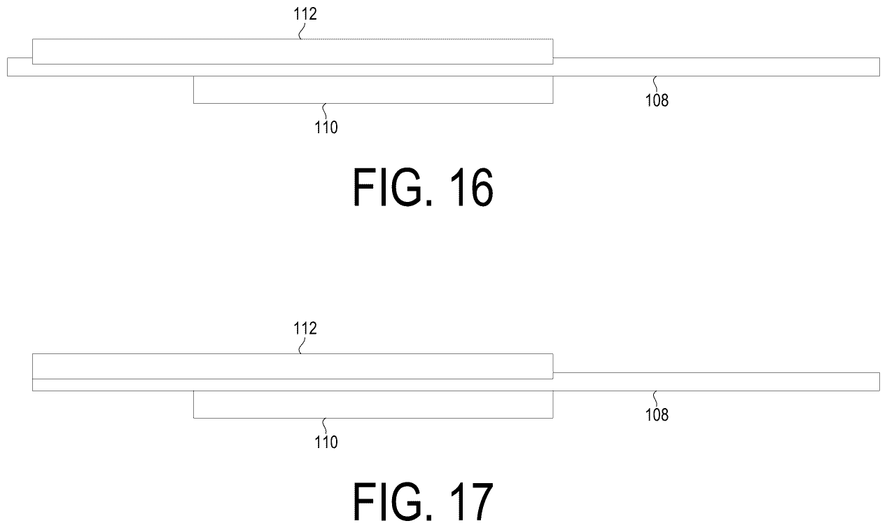

Referring now to FIG. 15, in some embodiments, a FAU 104 may incorporate the lid 112, as shown in FIG. 15. The FAU 104 includes a lid that extends over both the bottom 110 of the FAU 104 and over the V-groove array 202. Most of the length of the fibers 108 in the FAU 104 are covered by the top piece extended lid 112 for better protection of the optical fibers 108 and better position/parallelism tolerance control. The protrusion length of the fibers 108 can be designed to accommodate different epoxy dispense needs for different designs of PIC dies 102. For example, as shown in FIG. 16, the fibers 108 may extend beyond the lid 112, such as 0-5 millimeters beyond the lid 112. In other embodiments, as shown in FIG. 17, the ends of the fibers 108 may be flush with the lid 112.

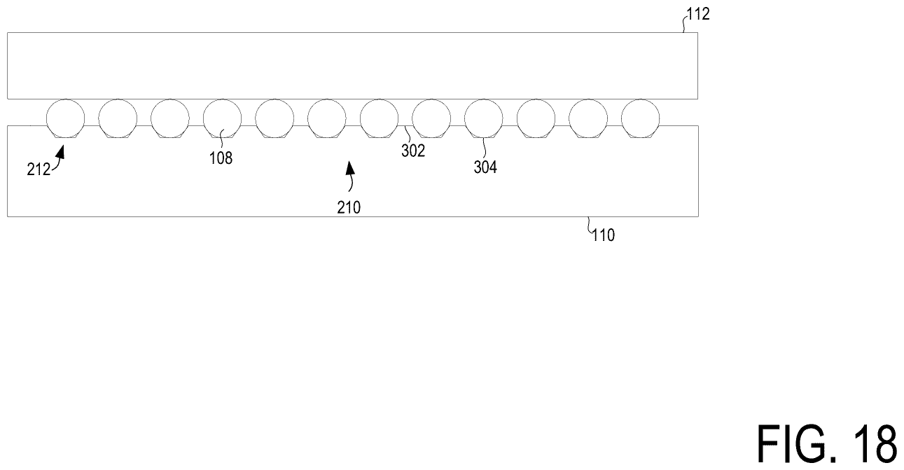

The FAU 104 with the extended lid 112 allows for flexibility in the region of the tips of the optical fibers 108, giving more degrees of freedom to accommodate various designs of a V-groove array 202 in the PIC dies 102 with a commonly designed lid 112 for the FAU 104. For example, referring now to FIG. 18, in one embodiment, a front view of the FAU 104 with the extended lid 112 is shown. In such an embodiment, the lid 112 is flat, and the base 110 has a V-groove array 210 to hold the optical fibers 108. The part of the optical fibers 108 above the V-groove array 210 may be glued to the flat surface of the extended lid 112, and the part of the optical fibers 108 that mate with the V-groove array 202 of the PIC die 102 may not be glued to the flat surface of the extended lid 112. The V-groove array 210 on the base 110 of the FAU 104 allows for control of fiber position/parallelism tolerance. In some embodiments, the warping mapping curvature described above in regard to FIGS. 12-14 may be implemented in such a design, allowing for better alignment accuracy, particularly for an FAU 104 with higher fiber count.

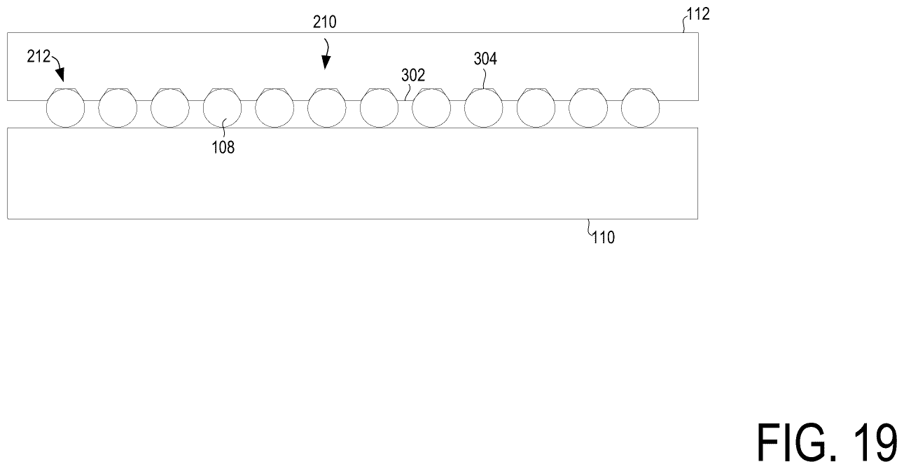

In another example, referring now to FIG. 19, in one embodiment, a front view of the FAU 104 with the extended lid 112 is shown. In such an embodiment, the base 110 is flat, and the lid 112 has an extended V-groove array 210 to hold the optical fibers 108. The V-groove array 210 can provide high alignment accuracy of the fiber array 106 to the V-groove array 202 on the PIC die 102. This is because the V-groove array 210 of the lid 112 and V-groove array 202 of the PIC die 102 will sandwich the fiber array 106 in between to provide even tighter control on fiber position/parallelism tolerance. This type design may require co-design of the FAU 104 and the PIC die 102 to ensure manufacturability to have enough gap distance in between the lid 112 and the PIC die 102 to prevent interference and proper epoxy dispense and thickness control. In some embodiments, the channels 114 and/or channels 116 may be included in the extended lid 112. Additionally or alternatively, in some embodiments, the warping mapping curvature described above in regard to FIGS. 12-14 may be implemented in such a design.

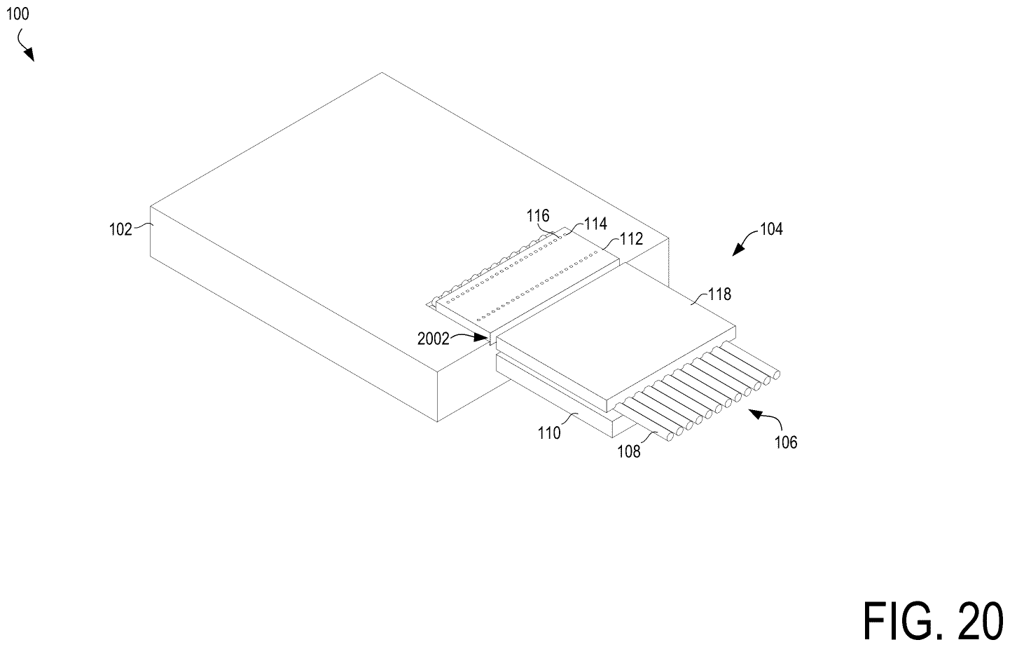

In another example, referring now to FIG. 20, in one embodiment, a FAU 104 may have a base 110 and/or top 118 that is spaced apart from the 112, as shown in FIG. 20. The base 110 and/or top 118 may be spaced apart by any suitable amount, such as 1-5 millimeters. The spacing may depend on how much the fibers 108 extend beyond the top 118 towards the PIC die 102.

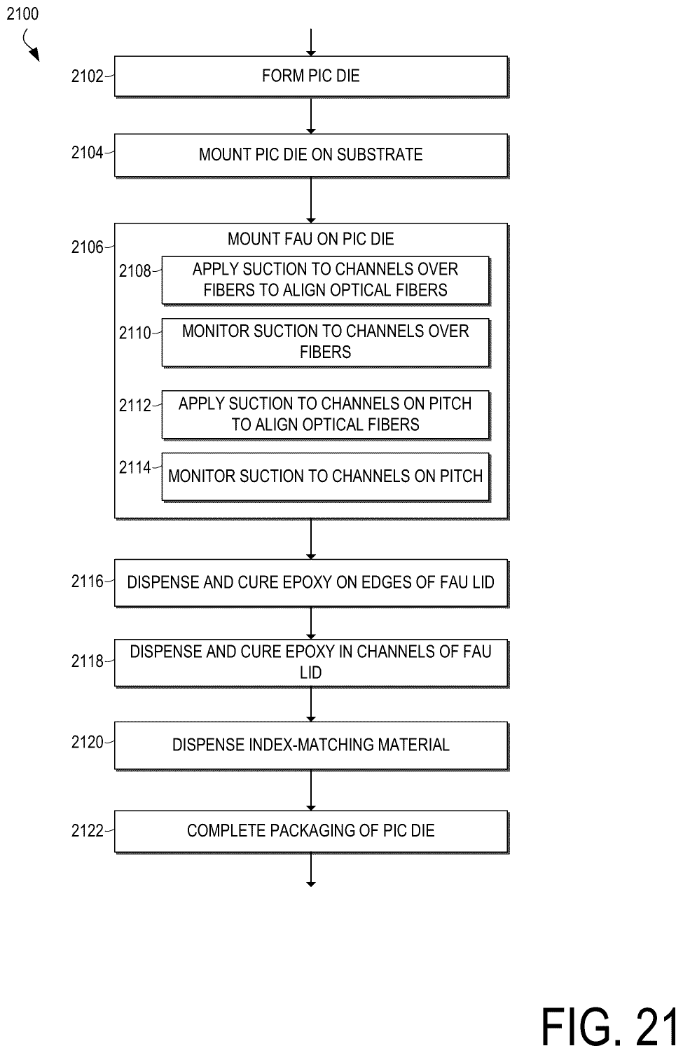

Referring now to FIG. 21, in one embodiment, a flowchart for a method 2100 for manufacturing a system including a PIC die and a fiber array unit is shown. The method 2100 may be executed by a technician and/or by one or more automated machines. In some embodiments, one or more machines may be programmed to do some or all of the steps of the method 2100. Such a machine may include, e.g., a memory, a processor, data storage, etc. The memory and/or data storage may store instructions that, when executed by the machine, cause the machine to perform some or all of the steps of the method 2100. The method 2100 may use any suitable set of techniques that are used in semiconductor processing, such as chemical vapor deposition, atomic layer deposition, physical layer deposition, molecular beam epitaxy, layer transfer, photolithography, ion implantation, dry etching, wet etching, selective laser etching, thermal treatments, flip chip, layer transfer, magnetron sputter deposition, pulsed laser deposition, laser machining, 3D photolithography, etc. It should be appreciated that the method 2100 is merely one embodiment of a method to create one embodiment of a system and other methods may be used to create any suitable embodiment of the system. In some embodiments, steps of the method 2100 may be performed in a different order than that shown in the flowchart.

The method 2100 begins in block 2102, in which a PIC die 102 is formed. The PIC die 102 may include active or passive optical elements such as splitters, couplers, filters, optical amplifiers, lasers, photodetectors, modulators, etc. The PIC die 102 may include electrical connections for connections to a substrate and/or an EIC die, such as for power delivery, sending and receiving data, and/or the like. In block 2104, the PIC die 102 may be mounted on a substrate, such as substrate 1202 and/or 1204. In an illustrative embodiment, the amount of warpage on the PIC die 102 and, in particular, in a region of the PIC die 102 including the V-groove array 202 is well-characterized. The amount of warpage may be characterized based on previous manufacturing of the same or similar component, or the amount of warpage may be characterized for each PIC die 102 after it is mounted.

In block 2106, an FAU 104 is mounted on the PIC die 102. The FAU lid 112 may have a shape designed to match the warpage of the PIC die 102. In block 2108, as part of mounting the FAU 104, suction is applied to the channels 116 to align the optical fibers 108 into the V-grooves 212 of the lid 112. In block 2110, the suction on the channels 116 over the fibers 108 is monitored. If airflow is higher than a threshold amount or pressure difference is below a threshold amount, that suggests that the optical fiber 108 is not well-seated in the V-groove 212. Some corrective action may be taken in response to such an occurrence, such as trying again, discarding a component, raising a warning to an operator, etc.

In block 2112, as the lid 112 and fibers 108 begin to be moved into place on the PIC die 102, suction is also applied to the channels 114 on pitch. In block 2114, the suction on the channels 114 on pitch is monitored. In some embodiments, the vacuum signal may be used as a cutoff condition for Z-movement instead of or in addition to a force and/or signal. As the FAU 104 is put in place and the channels 114 are close to the PIC die 102, the air flow through the channels 114 drops and/or the pressure differential increases. The air flow and/or pressure differential passing a threshold value may be interpreted as placement of the FAU 104 being complete. If air flow and/or pressure differential does not pass a threshold value as expected, an error may be detected, and corrective action may be taken, such as trying again, discarding a component, raising a warning to an operator, etc.

In block 2116, epoxy is dispensed and cured around the edges of the FAU lid 112. In block 2118, after the lid 112 is released, epoxy can be dispensed into the channels 114, 116 and cured, holding the lid 112 and fibers 108 in place.

Additionally or alternatively, in some embodiments, another bonding approach may be used. In one embodiment, a lid 112 may be bonded with thermal compression bonding. In this case, some or all of the channels 114 on pitch can be filled with a paste of metal with low melting point, such as tin and its alloys. After the lid 112 pitch touches the pitch of the V-groove array 202 of the PIC die 102, pitch, heat will be applied to ramp up the lid 112 to, e.g., over above 250° C. to form a joint between the pitch of the lid 112 and the pitch of the V-groove array 202 of the PIC die 102.

In block 2120, index-matching material is dispensed between the optical fibers 108 and the waveguides 208. The index-matching material may be dispensed using capillary underfill. The index-matching material can be cured in place.

In block 2122, the packaging of the PIC die 102 is complete. The PIC die 102 may be packaged with other components, such as one or more electronic integrated circuit (EIC) dies, other electrical and/or optical components, circuit boards, etc.

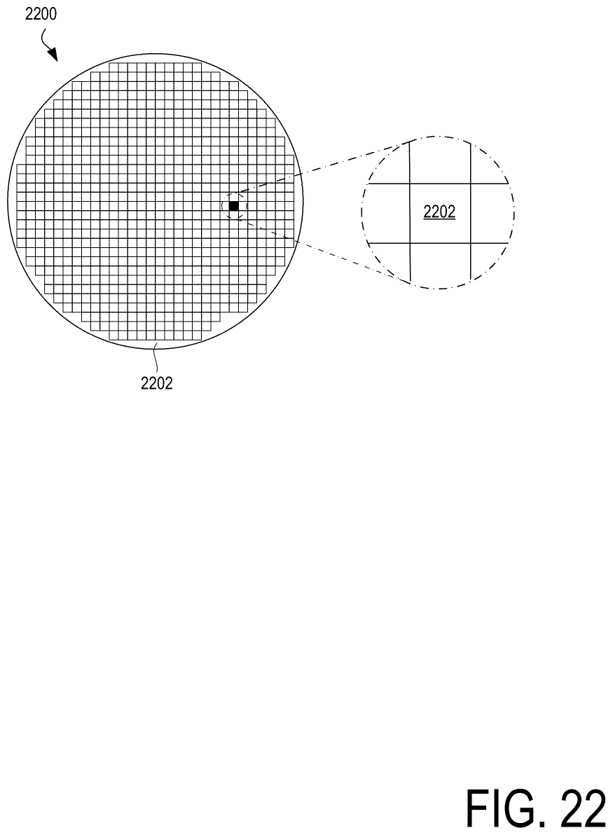

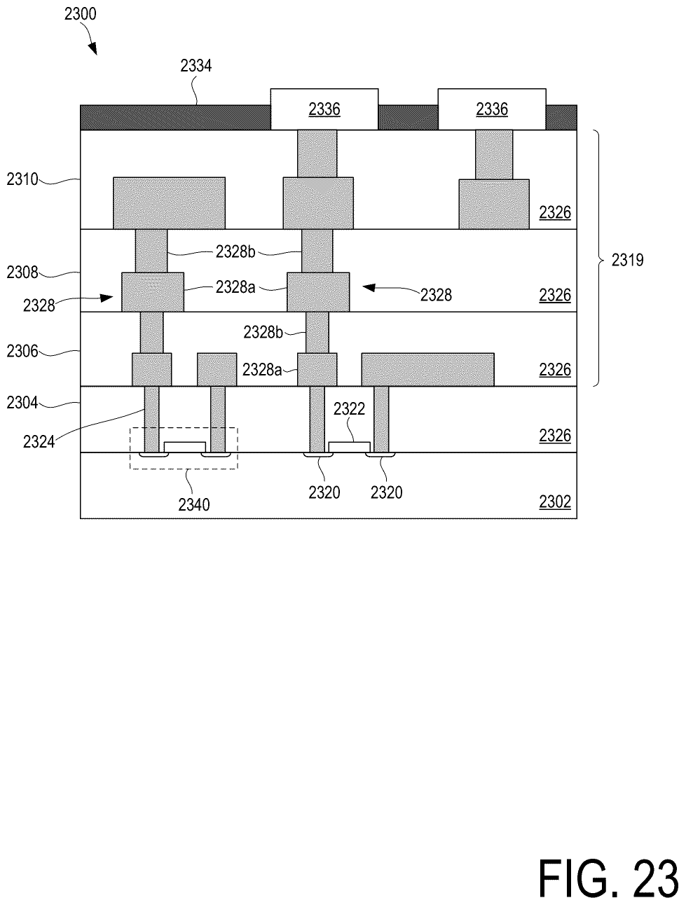

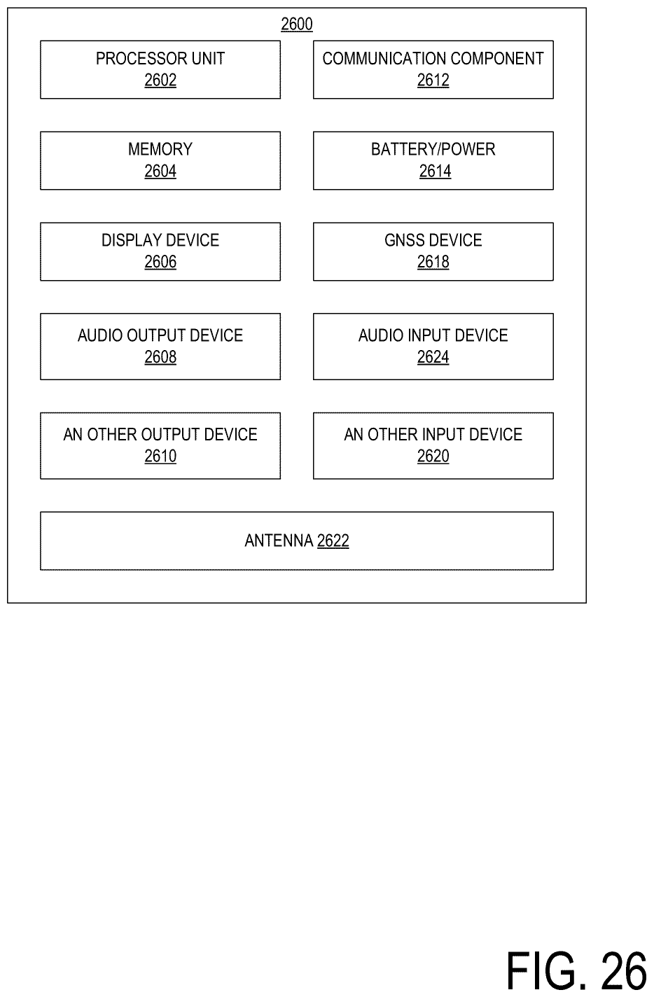

FIG. 22 is a top view of a wafer 2200 and dies 2202 that may be included in any of the systems 100 disclosed herein (e.g., as any suitable ones of the dies 102). The wafer 2200 may be composed of semiconductor material and may include one or more dies 2202 having integrated circuit structures formed on a surface of the wafer 2200. The individual dies 2202 may be a repeating unit of an integrated circuit product that includes any suitable integrated circuit. After the fabrication of the semiconductor product is complete, the wafer 2200 may undergo a singulation process in which the dies 2202 are separated from one another to provide discrete “chips” of the integrated circuit product. The die 2202 may be any of the dies 102 disclosed herein. The die 2202 may include one or more transistors (e.g., some of the transistors 2340 of FIG. 23, discussed below), supporting circuitry to route electrical signals to the transistors, passive components (e.g., signal traces, resistors, capacitors, or inductors), and/or any other integrated circuit components. In some embodiments, the wafer 2200 or the die 2202 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 2202. For example, a memory array formed by multiple memory devices may be formed on a same die 2202 as a processor unit (e.g., the processor unit 2602 of FIG. 26) or other logic that is configured to store information in the memory devices or execute instructions stored in the memory array. Various ones of the systems 100 disclosed herein may be manufactured using a die-to-wafer assembly technique in which some dies 102 are attached to a wafer 2200 that include others of the dies 102, and the wafer 2200 is subsequently singulated.

FIG. 23 is a cross-sectional side view of an integrated circuit device 2300 that may be included in any of the systems 100 disclosed herein (e.g., in any of the dies 102). One or more of the integrated circuit devices 2300 may be included in one or more dies 2202 (FIG. 22). The integrated circuit device 2300 may be formed on a die substrate 2302 (e.g., the wafer 2200 of FIG. 22) and may be included in a die (e.g., the die 2202 of FIG. 22). The die substrate 2302 may be a semiconductor substrate composed of semiconductor material systems including, for example, n-type or p-type materials systems (or a combination of both). The die substrate 2302 may include, for example, a crystalline substrate formed using a bulk silicon or a silicon-on-insulator (SOI) substructure. In some embodiments, the die substrate 2302 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 2302. Although a few examples of materials from which the die substrate 2302 may be formed are described here, any material that may serve as a foundation for an integrated circuit device 2300 may be used. The die substrate 2302 may be part of a singulated die (e.g., the dies 2202 of FIG. 22) or a wafer (e.g., the wafer 2200 of FIG. 22).

The integrated circuit device 2300 may include one or more device layers 2304 disposed on the die substrate 2302. The device layer 2304 may include features of one or more transistors 2340 (e.g., metal oxide semiconductor field-effect transistors (MOSFETs)) formed on the die substrate 2302. The transistors 2340 may include, for example, one or more source and/or drain (S/D) regions 2320, a gate 2322 to control current flow between the S/D regions 2320, and one or more S/D contacts 2324 to route electrical signals to/from the S/D regions 2320. The transistors 2340 may include additional features not depicted for the sake of clarity, such as device isolation regions, gate contacts, and the like. The transistors 2340 are not limited to the type and configuration depicted in FIG. 23 and may include a wide variety of other types and configurations such as, for example, planar transistors, non-planar transistors, or a combination of both. Non-planar transistors may include FinFET transistors, such as double-gate transistors or tri-gate transistors, and wrap-around or all-around gate transistors, such as nanoribbon, nanosheet, or nanowire transistors.

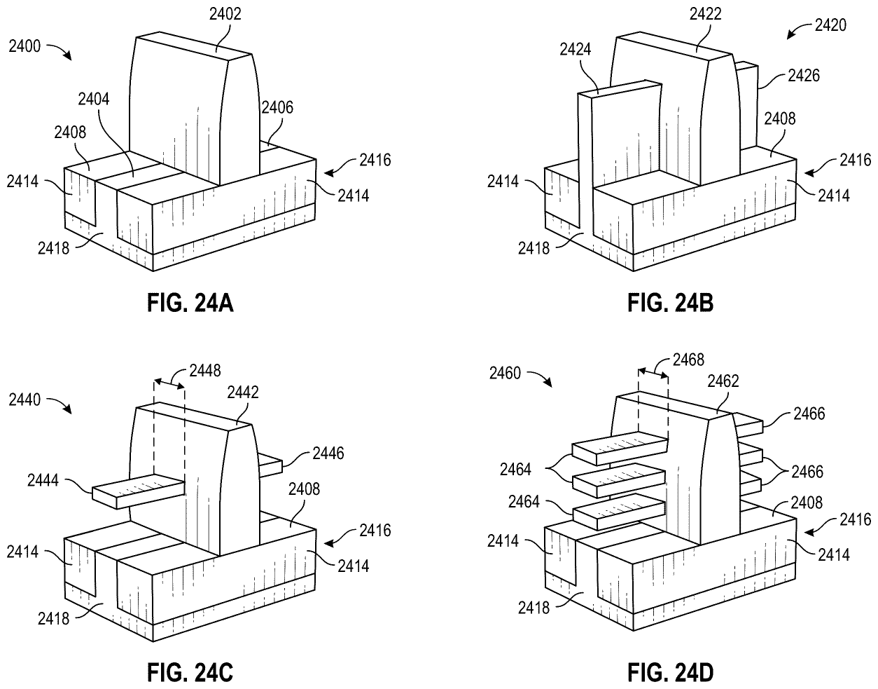

FIGS. 24A-24D are simplified perspective views of example planar, FinFET, gate-all-around, and stacked gate-all-around transistors. The transistors illustrated in FIGS. 24A-24D are formed on a substrate 2416 having a surface 2408. Isolation regions 2414 separate the source and drain regions of the transistors from other transistors and from a bulk region 2418 of the substrate 2416.

FIG. 24A is a perspective view of an example planar transistor 2400 comprising a gate 2402 that controls current flow between a source region 2404 and a drain region 2406. The transistor 2400 is planar in that the source region 2404 and the drain region 2406 are planar with respect to the substrate surface 2408.

FIG. 24B is a perspective view of an example FinFET transistor 2420 comprising a gate 2422 that controls current flow between a source region 2424 and a drain region 2426. The transistor 2420 is non-planar in that the source region 2424 and the drain region 2426 comprise “fins” that extend upwards from the substrate surface 2428. As the gate 2422 encompasses three sides of the semiconductor fin that extends from the source region 2424 to the drain region 2426, the transistor 2420 can be considered a tri-gate transistor. FIG. 24B illustrates one S/D fin extending through the gate 2422, but multiple S/D fins can extend through the gate of a FinFET transistor.

FIG. 24C is a perspective view of a gate-all-around (GAA) transistor 2440 comprising a gate 2442 that controls current flow between a source region 2444 and a drain region 2446. The transistor 2440 is non-planar in that the source region 2444 and the drain region 2446 are elevated from the substrate surface 2428.

FIG. 24D is a perspective view of a GAA transistor 2460 comprising a gate 2462 that controls current flow between multiple elevated source regions 2464 and multiple elevated drain regions 2466. The transistor 2460 is a stacked GAA transistor as the gate controls the flow of current between multiple elevated S/D regions stacked on top of each other. The transistors 2440 and 2460 are considered gate-all-around transistors as the gates encompass all sides of the semiconductor portions that extends from the source regions to the drain regions. The transistors 2440 and 2460 can alternatively be referred to as nanowire, nanosheet, or nanoribbon transistors depending on the width (e.g., widths 2448 and 2468 of transistors 2440 and 2460, respectively) of the semiconductor portions extending through the gate.

Returning to FIG. 23, a transistor 2340 may include a gate 2322 formed of at least two layers, a gate dielectric and a gate electrode. The gate dielectric may include one layer or a stack of layers. The one or more layers may include silicon oxide, silicon dioxide, silicon carbide, and/or a high-k dielectric material.

The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 2340 is to be a p-type metal oxide semiconductor (PMOS) or an n-type metal oxide semiconductor (NMOS) transistor. In some implementations, the gate electrode may consist of a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 2340 along the source-channel-drain direction, the gate electrode may consist of a U-shaped structure that includes a bottom portion substantially parallel to the surface of the die substrate 2302 and two sidewall portions that are substantially perpendicular to the top surface of the die substrate 2302. In other embodiments, at least one of the metal layers that form the gate electrode may simply be a planar layer that is substantially parallel to the top surface of the die substrate 2302 and does not include sidewall portions substantially perpendicular to the top surface of the die substrate 2302. In other embodiments, the gate electrode may consist of a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 2320 may be formed within the die substrate 2302 adjacent to the gate 2322 of individual transistors 2340. The S/D regions 2320 may be formed using an implantation/diffusion process or an etching/deposition process, for example. In the former process, dopants such as boron, aluminum, antimony, phosphorous, or arsenic may be ion-implanted into the die substrate 2302 to form the S/D regions 2320. An annealing process that activates the dopants and causes them to diffuse farther into the die substrate 2302 may follow the ion-implantation process. In the latter process, the die substrate 2302 may first be etched to form recesses at the locations of the S/D regions 2320. An epitaxial deposition process may then be carried out to fill the recesses with material that is used to fabricate the S/D regions 2320. In some implementations, the S/D regions 2320 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 2320 may be formed using one or more alternate semiconductor materials such as germanium or a group III-V material or alloy. In further embodiments, one or more layers of metal and/or metal alloys may be used to form the S/D regions 2320.

Electrical signals, such as power and/or input/output (I/O) signals, may be routed to and/or from the devices (e.g., transistors 2340) of the device layer 2304 through one or more interconnect layers disposed on the device layer 2304 (illustrated in FIG. 23 as interconnect layers 2306-2310). For example, electrically conductive features of the device layer 2304 (e.g., the gate 2322 and the S/D contacts 2324) may be electrically coupled with the interconnect structures 2328 of the interconnect layers 2306-2310. The one or more interconnect layers 2306-2310 may form a metallization stack (also referred to as an “ILD stack”) 2319 of the integrated circuit device 2300.

The interconnect structures 2328 may be arranged within the interconnect layers 2306-2310 to route electrical signals according to a wide variety of designs; in particular, the arrangement is not limited to the particular configuration of interconnect structures 2328 depicted in FIG. 23. Although a particular number of interconnect layers 2306-2310 is depicted in FIG. 23, embodiments of the present disclosure include integrated circuit devices having more or fewer interconnect layers than depicted.

In some embodiments, the interconnect structures 2328 may include lines 2328a and/or vias 2328b filled with an electrically conductive material such as a metal. The lines 2328a may be arranged to route electrical signals in a direction of a plane that is substantially parallel with a surface of the die substrate 2302 upon which the device layer 2304 is formed. For example, the lines 2328a may route electrical signals in a direction in and out of the page and/or in a direction across the page. The vias 2328b may be arranged to route electrical signals in a direction of a plane that is substantially perpendicular to the surface of the die substrate 2302 upon which the device layer 2304 is formed. In some embodiments, the vias 2328b may electrically couple lines 2328a of different interconnect layers 2306-2310 together.

The interconnect layers 2306-2310 may include a dielectric material 2326 disposed between the interconnect structures 2328, as shown in FIG. 23. In some embodiments, dielectric material 2326 disposed between the interconnect structures 2328 in different ones of the interconnect layers 2306-2310 may have different compositions; in other embodiments, the composition of the dielectric material 2326 between different interconnect layers 2306-2310 may be the same. The device layer 2304 may include a dielectric material 2326 disposed between the transistors 2340 and a bottom layer of the metallization stack as well. The dielectric material 2326 included in the device layer 2304 may have a different composition than the dielectric material 2326 included in the interconnect layers 2306-2310; in other embodiments, the composition of the dielectric material 2326 in the device layer 2304 may be the same as a dielectric material 2326 included in any one of the interconnect layers 2306-2310.

A first interconnect layer 2306 (referred to as Metal 1 or “M1”) may be formed directly on the device layer 2304. In some embodiments, the first interconnect layer 2306 may include lines 2328a and/or vias 2328b, as shown. The lines 2328a of the first interconnect layer 2306 may be coupled with contacts (e.g., the S/D contacts 2324) of the device layer 2304. The vias 2328b of the first interconnect layer 2306 may be coupled with the lines 2328a of a second interconnect layer 2308.

The second interconnect layer 2308 (referred to as Metal 2 or “M2”) may be formed directly on the first interconnect layer 2306. In some embodiments, the second interconnect layer 2308 may include via 2328b to couple the lines 2328 of the second interconnect layer 2308 with the lines 2328a of a third interconnect layer 2310. Although the lines 2328a and the vias 2328b are structurally delineated with a line within individual interconnect layers for the sake of clarity, the lines 2328a and the vias 2328b may be structurally and/or materially contiguous (e.g., simultaneously filled during a dual-damascene process) in some embodiments.

The third interconnect layer 2310 (referred to as Metal 3 or “M3”) (and additional interconnect layers, as desired) may be formed in succession on the second interconnect layer 2308 according to similar techniques and configurations described in connection with the second interconnect layer 2308 or the first interconnect layer 2306. In some embodiments, the interconnect layers that are “higher up” in the metallization stack 2319 in the integrated circuit device 2300 (i.e., farther away from the device layer 2304) may be thicker that the interconnect layers that are lower in the metallization stack 2319, with lines 2328a and vias 2328b in the higher interconnect layers being thicker than those in the lower interconnect layers.

The integrated circuit device 2300 may include a solder resist material 2334 (e.g., polyimide or similar material) and one or more conductive contacts 2336 formed on the interconnect layers 2306-2310. In FIG. 23, the conductive contacts 2336 are illustrated as taking the form of bond pads. The conductive contacts 2336 may be electrically coupled with the interconnect structures 2328 and configured to route the electrical signals of the transistor(s) 2340 to external devices. For example, solder bonds may be formed on the one or more conductive contacts 2336 to mechanically and/or electrically couple an integrated circuit die including the integrated circuit device 2300 with another component (e.g., a printed circuit board). The integrated circuit device 2300 may include additional or alternate structures to route the electrical signals from the interconnect layers 2306-2310; for example, the conductive contacts 2336 may include other analogous features (e.g., posts) that route the electrical signals to external components.

In some embodiments in which the integrated circuit device 2300 is a double-sided die, the integrated circuit device 2300 may include another metallization stack (not shown) on the opposite side of the device layer(s) 2304. This metallization stack may include multiple interconnect layers as discussed above with reference to the interconnect layers 2306-2310, to provide conductive pathways (e.g., including conductive lines and vias) between the device layer(s) 2304 and additional conductive contacts (not shown) on the opposite side of the integrated circuit device 2300 from the conductive contacts 2336.

In other embodiments in which the integrated circuit device 2300 is a double-sided die, the integrated circuit device 2300 may include one or more through silicon vias (TSVs) through the die substrate 2302; these TSVs may make contact with the device layer(s) 2304, and may provide conductive pathways between the device layer(s) 2304 and additional conductive contacts (not shown) on the opposite side of the integrated circuit device 2300 from the conductive contacts 2336. In some embodiments, TSVs extending through the substrate can be used for routing power and ground signals from conductive contacts on the opposite side of the integrated circuit device 2300 from the conductive contacts 2336 to the transistors 2340 and any other components integrated into the die 2300, and the metallization stack 2319 can be used to route I/O signals from the conductive contacts 2336 to transistors 2340 and any other components integrated into the die 2300.

Multiple integrated circuit devices 2300 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

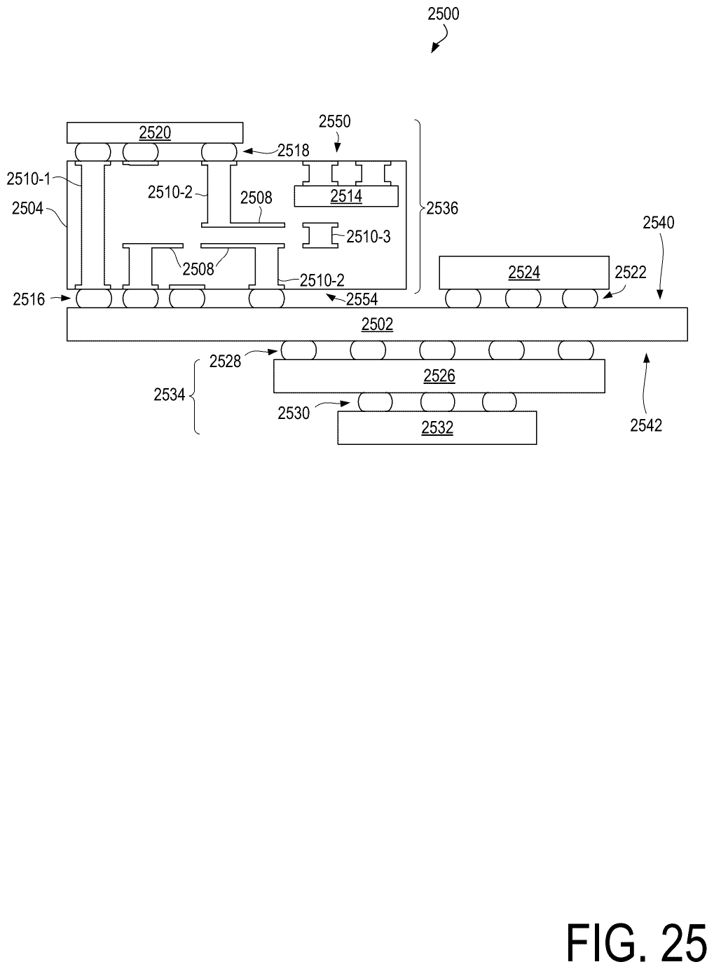

FIG. 25 is a cross-sectional side view of an integrated circuit device assembly 2500 that may include any of the systems 100 disclosed herein. In some embodiments, the integrated circuit device assembly 2500 may be a system 100. The integrated circuit device assembly 2500 includes a number of components disposed on a circuit board 2502 (which may be a motherboard, system board, mainboard, etc.). The integrated circuit device assembly 2500 includes components disposed on a first face 2540 of the circuit board 2502 and an opposing second face 2542 of the circuit board 2502; generally, components may be disposed on one or both faces 2540 and 2542. Any of the integrated circuit components discussed below with reference to the integrated circuit device assembly 2500 may take the form of any suitable ones of the embodiments of the systems 100 disclosed herein.

In some embodiments, the circuit board 2502 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 2502. In other embodiments, the circuit board 2502 may be a non-PCB substrate. In some embodiments the circuit board 2502 may be, for example, the circuit board 1202 or circuit board 1204. The integrated circuit device assembly 2500 illustrated in FIG. 25 includes a package-on-interposer structure 2536 coupled to the first face 2540 of the circuit board 2502 by coupling components 2516. The coupling components 2516 may electrically and mechanically couple the package-on-interposer structure 2536 to the circuit board 2502, and may include solder balls (as shown in FIG. 25), pins (e.g., as part of a pin grid array (PGA), contacts (e.g., as part of a land grid array (LGA)), male and female portions of a socket, an adhesive, an underfill material, and/or any other suitable electrical and/or mechanical coupling structure. The coupling components 2516 may serve as the coupling components illustrated or described for any of the substrate assembly or substrate assembly components described herein, as appropriate.

The package-on-interposer structure 2536 may include an integrated circuit component 2520 coupled to an interposer 2504 by coupling components 2518. The coupling components 2518 may take any suitable form for the application, such as the forms discussed above with reference to the coupling components 2516. Although a single integrated circuit component 2520 is shown in FIG. 25, multiple integrated circuit components may be coupled to the interposer 2504; indeed, additional interposers may be coupled to the interposer 2504. The interposer 2504 may provide an intervening substrate used to bridge the circuit board 2502 and the integrated circuit component 2520.

The integrated circuit component 2520 may be a packaged or unpacked integrated circuit product that includes one or more integrated circuit dies (e.g., the die 2202 of FIG. 22, the integrated circuit device 2300 of FIG. 23) and/or one or more other suitable components. A packaged integrated circuit component comprises one or more integrated circuit dies mounted on a package substrate with the integrated circuit dies and package substrate encapsulated in a casing material, such as a metal, plastic, glass, or ceramic. In one example of an unpackaged integrated circuit component 2520, a single monolithic integrated circuit die comprises solder bumps attached to contacts on the die. The solder bumps allow the die to be directly attached to the interposer 2504. The integrated circuit component 2520 can comprise one or more computing system components, such as one or more processor units (e.g., system-on-a-chip (SoC), processor core, graphics processor unit (GPU), accelerator, chipset processor), I/O controller, memory, or network interface controller. In some embodiments, the integrated circuit component 2520 can comprise one or more additional active or passive devices such as capacitors, decoupling capacitors, resistors, inductors, fuses, diodes, transformers, sensors, electrostatic discharge (ESD) devices, and memory devices.

In embodiments where the integrated circuit component 2520 comprises multiple integrated circuit dies, they dies can be of the same type (a homogeneous multi-die integrated circuit component) or of two or more different types (a heterogeneous multi-die integrated circuit component). A multi-die integrated circuit component can be referred to as a multi-chip package (MCP) or multi-chip module (MCM).

In addition to comprising one or more processor units, the integrated circuit component 2520 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Generally, the interposer 2504 may spread connections to a wider pitch or reroute a connection to a different connection. For example, the interposer 2504 may couple the integrated circuit component 2520 to a set of ball grid array (BGA) conductive contacts of the coupling components 2516 for coupling to the circuit board 2502. In the embodiment illustrated in FIG. 25, the integrated circuit component 2520 and the circuit board 2502 are attached to opposing sides of the interposer 2504; in other embodiments, the integrated circuit component 2520 and the circuit board 2502 may be attached to a same side of the interposer 2504. In some embodiments, three or more components may be interconnected by way of the interposer 2504.

In some embodiments, the interposer 2504 may be formed as a PCB, including multiple metal layers separated from one another by layers of dielectric material and interconnected by electrically conductive vias. In some embodiments, the interposer 2504 may be formed of an epoxy resin, a fiberglass-reinforced epoxy resin, an epoxy resin with inorganic fillers, a ceramic material, or a polymer material such as polyimide. In some embodiments, the interposer 2504 may be formed of alternate rigid or flexible materials that may include the same materials described above for use in a semiconductor substrate, such as silicon, germanium, and other group III-V and group IV materials. The interposer 2504 may include metal interconnects 2508 and vias 2510, including but not limited to through hole vias 2510-1 (that extend from a first face 2550 of the interposer 2504 to a second face 2554 of the interposer 2504), blind vias 2510-2 (that extend from the first or second faces 2550 or 2554 of the interposer 2504 to an internal metal layer), and buried vias 2510-3 (that connect internal metal layers).

In some embodiments, the interposer 2504 can comprise a silicon interposer. Through silicon vias (TSV) extending through the silicon interposer can connect connections on a first face of a silicon interposer to an opposing second face of the silicon interposer. In some embodiments, an interposer 2504 comprising a silicon interposer can further comprise one or more routing layers to route connections on a first face of the interposer 2504 to an opposing second face of the interposer 2504.

The interposer 2504 may further include embedded devices 2514, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 2504. The package-on-interposer structure 2536 may take the form of any of the package-on-interposer structures known in the art.

The integrated circuit device assembly 2500 may include an integrated circuit component 2524 coupled to the first face 2540 of the circuit board 2502 by coupling components 2522. The coupling components 2522 may take the form of any of the embodiments discussed above with reference to the coupling components 2516, and the integrated circuit component 2524 may take the form of any of the embodiments discussed above with reference to the integrated circuit component 2520.

The integrated circuit device assembly 2500 illustrated in FIG. 25 includes a package-on-package structure 2534 coupled to the second face 2542 of the circuit board 2502 by coupling components 2528. The package-on-package structure 2534 may include an integrated circuit component 2526 and an integrated circuit component 2532 coupled together by coupling components 2530 such that the integrated circuit component 2526 is disposed between the circuit board 2502 and the integrated circuit component 2532. The coupling components 2528 and 2530 may take the form of any of the embodiments of the coupling components 2516 discussed above, and the integrated circuit components 2526 and 2532 may take the form of any of the embodiments of the integrated circuit component 2520 discussed above. The package-on-package structure 2534 may be configured in accordance with any of the package-on-package structures known in the art.

FIG. 26 is a block diagram of an example electrical device 2600 that may include one or more of the systems 100 disclosed herein. For example, any suitable ones of the components of the electrical device 2600 may include one or more of the integrated circuit device assemblies 2500, integrated circuit components 2520, integrated circuit devices 2300, or integrated circuit dies 2202 disclosed herein, and may be arranged in any of the systems 100 disclosed herein. A number of components are illustrated in FIG. 26 as included in the electrical device 2600, but any one or more of these components may be omitted or duplicated, as suitable for the application. In some embodiments, some or all of the components included in the electrical device 2600 may be attached to one or more motherboards mainboards, or system boards. In some embodiments, one or more of these components are fabricated onto a single system-on-a-chip (SoC) die.

Additionally, in various embodiments, the electrical device 2600 may not include one or more of the components illustrated in FIG. 26, but the electrical device 2600 may include interface circuitry for coupling to the one or more components. For example, the electrical device 2600 may not include a display device 2606, but may include display device interface circuitry (e.g., a connector and driver circuitry) to which a display device 2606 may be coupled. In another set of examples, the electrical device 2600 may not include an audio input device 2624 or an audio output device 2608, but may include audio input or output device interface circuitry (e.g., connectors and supporting circuitry) to which an audio input device 2624 or audio output device 2608 may be coupled.

The electrical device 2600 may include one or more processor units 2602 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 2602 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electrical device 2600 may include a memory 2604, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 2604 may include memory that is located on the same integrated circuit die as the processor unit 2602. This memory may be used as cache memory (e.g., Level 1 (L1), Level 2 (L2), Level 3 (L3), Level 4 (L4), Last Level Cache (LLC)) and may include embedded dynamic random access memory (eDRAM) or spin transfer torque magnetic random access memory (STT-MRAM).

In some embodiments, the electrical device 2600 can comprise one or more processor units 2602 that are heterogeneous or asymmetric to another processor unit 2602 in the electrical device 2600. There can be a variety of differences between the processing units 2602 in a system in terms of a spectrum of metrics of merit including architectural, microarchitectural, thermal, power consumption characteristics, and the like. These differences can effectively manifest themselves as asymmetry and heterogeneity among the processor units 2602 in the electrical device 2600.

In some embodiments, the electrical device 2600 may include a communication component 2612 (e.g., one or more communication components). For example, the communication component 2612 can manage wireless communications for the transfer of data to and from the electrical device 2600. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 2612 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 2612 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 2612 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 2612 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 2612 may operate in accordance with other wireless protocols in other embodiments. The electrical device 2600 may include an antenna 2622 to facilitate wireless communications and/or to receive other wireless communications (such as AM or FM radio transmissions).

In some embodiments, the communication component 2612 may manage wired communications, such as electrical, optical, or any other suitable communication protocols (e.g., IEEE 802.3 Ethernet standards). As noted above, the communication component 2612 may include multiple communication components. For instance, a first communication component 2612 may be dedicated to shorter-range wireless communications such as Wi-Fi or Bluetooth, and a second communication component 2612 may be dedicated to longer-range wireless communications such as global positioning system (GPS), EDGE, GPRS, CDMA, WiMAX, LTE, EV-DO, or others. In some embodiments, a first communication component 2612 may be dedicated to wireless communications, and a second communication component 2612 may be dedicated to wired communications.

The electrical device 2600 may include battery/power circuitry 2614. The battery/power circuitry 2614 may include one or more energy storage devices (e.g., batteries or capacitors) and/or circuitry for coupling components of the electrical device 2600 to an energy source separate from the electrical device 2600 (e.g., AC line power).

The electrical device 2600 may include a display device 2606 (or corresponding interface circuitry, as discussed above). The display device 2606 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 2600 may include an audio output device 2608 (or corresponding interface circuitry, as discussed above). The audio output device 2608 may include any embedded or wired or wirelessly connected external device that generates an audible indicator, such as speakers, headsets, or earbuds.

The electrical device 2600 may include an audio input device 2624 (or corresponding interface circuitry, as discussed above). The audio input device 2624 may include any embedded or wired or wirelessly connected device that generates a signal representative of a sound, such as microphones, microphone arrays, or digital instruments (e.g., instruments having a musical instrument digital interface (MIDI) output). The electrical device 2600 may include a Global Navigation Satellite System (GNSS) device 2618 (or corresponding interface circuitry, as discussed above), such as a Global Positioning System (GPS) device. The GNSS device 2618 may be in communication with a satellite-based system and may determine a geolocation of the electrical device 2600 based on information received from one or more GNSS satellites, as known in the art.

The electrical device 2600 may include an other output device 2610 (or corresponding interface circuitry, as discussed above). Examples of the other output device 2610 may include an audio codec, a video codec, a printer, a wired or wireless transmitter for providing information to other devices, or an additional storage device.

The electrical device 2600 may include an other input device 2620 (or corresponding interface circuitry, as discussed above). Examples of the other input device 2620 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 2600 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 2600 may be any other electronic device that processes data. In some embodiments, the electrical device 2600 may comprise multiple discrete physical components. Given the range of devices that the electrical device 2600 can be manifested as in various embodiments, in some embodiments, the electrical device 2600 can be referred to as a computing device or a computing system.

### EXAMPLES

Illustrative examples of the technologies disclosed herein are provided below. An embodiment of the technologies may include any one or more, and any combination of, the examples described below.
Example 1 includes an apparatus comprising a lid for a fiber array unit comprising a body, wherein a plurality of grooves are defined in a first surface of the body, wherein individual grooves of the plurality of grooves are to hold an optical fiber, wherein a plurality of channels are defined in the body, wherein individual channels of the plurality of channels extend from a corresponding groove of the plurality of grooves to a second surface of the body, the second surface opposite the first surface.
Example 2 includes the subject matter of Example 1, and wherein the plurality of grooves comprise at least three grooves, wherein the at least three grooves extend from a first end face of the body to a second end face of the body, wherein the at least three grooves at the first end face follow an arced path such that no straight line can be drawn at the first end face that is not at least one micrometer away from at least one of the at least three grooves.
Example 3 includes the subject matter of any of Examples 1 and 2, and wherein the plurality of channels are at least partially filled with epoxy.
Example 4 includes the subject matter of any of Examples 1-3, and further including a photonic integrated circuit (PIC) die and the fiber array unit, the fiber array unit comprising a base; and a plurality of optical fibers, wherein the plurality of optical fibers are positioned between the base and the lid, wherein the plurality of optical fibers and the lid extend over the PIC die, wherein the base does not extend over the PIC die.
Example 5 includes the subject matter of any of Examples 1-4, and wherein the plurality of optical fibers extend past the lid.
Example 6 includes the subject matter of any of Examples 1-5, and wherein the plurality of optical fibers do not extend past the lid.
Example 7 includes the subject matter of any of Examples 1-6, and wherein the base comprises a flat surface, wherein the plurality of optical fibers are adjacent the flat surface.
Example 8 includes the subject matter of any of Examples 1-7, and wherein the lid comprises silicon.
Example 9 includes the subject matter of any of Examples 1-8, and wherein the lid comprises silicon and oxygen.
Example 10 includes an integrated circuit package comprising the apparatus of Example 1, further comprising the fiber array unit, a photonic integrated circuit (PIC) die and an electronic integrated circuit (EIC) die, wherein the EIC die is electrically coupled to the PIC die, wherein the fiber array unit is mated with the PIC die.
Example 11 includes an apparatus comprising a lid for a fiber array unit comprising a body, wherein at least three grooves are defined in a first surface of the body, wherein the at least three grooves extend from a first end face of the body to a second end face of the body, wherein the at least three grooves at the first end face follow an arced path such that no straight line can be drawn at the first end face that is not at least one micrometer away from at least one of the at least three grooves.
Example 12 includes the subject matter of Example 11, and wherein individual grooves of the at least three grooves are to hold an optical fiber, wherein a plurality of channels are defined in the body, wherein individual channels of the plurality of channels extend from a corresponding groove of the at least three grooves to a second surface of the body, the second surface opposite the first surface.
Example 13 includes the subject matter of any of Examples 11 and 12, and wherein the plurality of channels are at least partially filled with epoxy.
Example 14 includes the subject matter of any of Examples 11-13, and further including a photonic integrated circuit (PIC) die and the fiber array unit, the fiber array unit comprising a base; and a plurality of optical fibers, wherein the plurality of optical fibers are positioned between the base and the lid, wherein the plurality of optical fibers and the lid extend over the PIC die, wherein the base does not extend over the PIC die.
Example 15 includes the subject matter of any of Examples 11-14, and wherein the plurality of optical fibers extend past the lid.
Example 16 includes the subject matter of any of Examples 11-15, and wherein the plurality of optical fibers do not extend past the lid.
Example 17 includes the subject matter of any of Examples 11-16, and wherein the base comprises a flat surface, wherein the plurality of optical fibers are adjacent the flat surface.
Example 18 includes the subject matter of any of Examples 11-17, and wherein the lid comprises silicon.
Example 19 includes the subject matter of any of Examples 11-18, and wherein the lid comprises silicon and oxygen.
Example 20 includes an integrated circuit package comprising the apparatus of Example 11, further comprising the fiber array unit, a photonic integrated circuit (PIC) die and an electronic integrated circuit (EIC) die, wherein the EIC die is electrically coupled to the PIC die, wherein the fiber array unit is mated with the PIC die.
Example 21 includes a method comprising attaching a fiber array unit (FAU) comprising a plurality of optical fibers to a photonic integrated circuit (PIC) die, wherein a lid for the fiber array unit comprises a body, wherein a plurality of grooves are defined in a first surface of the body, wherein individual grooves of the plurality of grooves are to hold an optical fiber, wherein a plurality of channels are defined in the body, wherein individual channels of the plurality of channels extend from a corresponding groove of the plurality of grooves to a second surface of the body, the second surface opposite the first surface, wherein attaching the FAU comprises applying suction to the plurality of optical fibers through the plurality of channels.
Example 22 includes the subject matter of Example 21, and wherein a second plurality of channels are defined in the body, wherein individual channels of the second plurality of channels extend from the first surface between the plurality of grooves to the second surface of the body, wherein attaching the FAU comprises applying suction to the second plurality of channels.
Example 23 includes the subject matter of any of Examples 21 and 22, and wherein attaching the FAU comprises monitoring a pressure or airflow at the second plurality of channels; and determining an alignment of the FAU to the PIC die based on the pressure or airflow at the second plurality of channels.
Example 24 includes the subject matter of any of Examples 21-23, and wherein attaching the FAU comprises applying epoxy through the plurality of channels.
Example 25 includes the subject matter of any of Examples 21-24, and further including determining an amount of warpage in the PIC die; and forming the lid based on the amount of warpage in the PIC die.

1. An apparatus comprising:
a lid for a fiber array unit comprising:
a body, wherein a plurality of grooves are defined in a first surface of the body,
wherein individual grooves of the plurality of grooves are to hold an optical fiber,
wherein a plurality of channels are defined in the body, wherein individual channels of the plurality of channels extend from a corresponding groove of the plurality of grooves to a second surface of the body, the second surface opposite the first surface.

2. The apparatus of claim 1, wherein the plurality of grooves comprise at least three grooves, wherein the at least three grooves extend from a first end face of the body to a second end face of the body,
wherein the at least three grooves at the first end face follow an arced path such that no straight line can be drawn at the first end face that is not at least one micrometer away from at least one of the at least three grooves.

3. The apparatus of claim 1, wherein the plurality of channels are at least partially filled with epoxy.

4. The apparatus of claim 1, further comprising a photonic integrated circuit (PIC) die and the fiber array unit, the fiber array unit comprising:
a base; and
a plurality of optical fibers,
wherein the plurality of optical fibers are positioned between the base and the lid, wherein the plurality of optical fibers and the lid extend over the PIC die, wherein the base does not extend over the PIC die.

5. The apparatus of claim 4, wherein the plurality of optical fibers extend past the lid.

6. The apparatus of claim 4, wherein the plurality of optical fibers do not extend past the lid.

7. The apparatus of claim 4, wherein the base comprises a flat surface, wherein the plurality of optical fibers are adjacent the flat surface.

8. The apparatus of claim 1, wherein the lid comprises silicon.

9. The apparatus of claim 1, wherein the lid comprises silicon and oxygen.

10. An integrated circuit package comprising the apparatus of claim 1, further comprising the fiber array unit, a photonic integrated circuit (PIC) die and an electronic integrated circuit (EIC) die, wherein the EIC die is electrically coupled to the PIC die, wherein the fiber array unit is mated with the PIC die.

11. An apparatus comprising:
a lid for a fiber array unit comprising:
a body, wherein at least three grooves are defined in a first surface of the body,
wherein the at least three grooves extend from a first end face of the body to a second end face of the body,
wherein the at least three grooves at the first end face follow an arced path such that no straight line can be drawn at the first end face that is not at least one micrometer away from at least one of the at least three grooves.

12. The apparatus of claim 11,
wherein individual grooves of the at least three grooves are to hold an optical fiber,
wherein a plurality of channels are defined in the body, wherein individual channels of the plurality of channels extend from a corresponding groove of the at least three grooves to a second surface of the body, the second surface opposite the first surface.

13. The apparatus of claim 12, wherein the plurality of channels are at least partially filled with epoxy.

14. The apparatus of claim 11, further comprising a photonic integrated circuit (PIC) die and the fiber array unit, the fiber array unit comprising:
a base; and
a plurality of optical fibers,
wherein the plurality of optical fibers are positioned between the base and the lid, wherein the plurality of optical fibers and the lid extend over the PIC die, wherein the base does not extend over the PIC die.

15. An integrated circuit package comprising the apparatus of claim 11, further comprising the fiber array unit, a photonic integrated circuit (PIC) die and an electronic integrated circuit (EIC) die, wherein the EIC die is electrically coupled to the PIC die, wherein the fiber array unit is mated with the PIC die.

16. A method comprising:
attaching a fiber array unit (FAU) comprising a plurality of optical fibers to a photonic integrated circuit (PIC) die, wherein a lid for the fiber array unit comprises a body, wherein a plurality of grooves are defined in a first surface of the body, wherein individual grooves of the plurality of grooves are to hold an optical fiber, wherein a plurality of channels are defined in the body, wherein individual channels of the plurality of channels extend from a corresponding groove of the plurality of grooves to a second surface of the body, the second surface opposite the first surface,
wherein attaching the FAU comprises applying suction to the plurality of optical fibers through the plurality of channels.

17. The method of claim 16, wherein a second plurality of channels are defined in the body, wherein individual channels of the second plurality of channels extend from the first surface between the plurality of grooves to the second surface of the body,
wherein attaching the FAU comprises applying suction to the second plurality of channels.

18. The method of claim 17, wherein attaching the FAU comprises:
monitoring a pressure or airflow at the second plurality of channels; and
determining an alignment of the FAU to the PIC die based on the pressure or airflow at the second plurality of channels.

19. The method of claim 16, wherein attaching the FAU comprises applying epoxy through the plurality of channels.

20. The method of claim 16, further comprising
determining an amount of warpage in the PIC die; and
forming the lid based on the amount of warpage in the PIC die.
